(19) United States
(12) Patent Application Publication
(10) Pub. No.: US 2025/0373396 A1
(43) Pub. Date: Dec. 4, 2025

(54) METHOD AND USER EQUIPMENT RELATING TO TCI STATE IN 5G NR

(71) Applicant: Metapex Inc., Seoul (KR)

(72) Inventor: Sang Geun YU, Seoul (KR)

(21) Appl. No.: 19/088,305

(22) Filed: Mar. 24, 2025

(30) Foreign Application Priority Data
May 31, 2024 (KR) 10-2024-0071548
Mar. 13, 2025 (KR) 10-2025-0032861

(51) Int. Cl. H04L 5/00; H04W 72/21

(52) U.S. Cl. CPC H04L 5/0053; H04W 72/21

(57) ABSTRACT

There is provided an operation method of user equipment (UE), comprising: receiving a higher layer configuration including more than one transmission configuration indicator (TCI) state; and if only one TCI state in the more than one TCI state is used as an indicated TCI state, determining a sounding reference signal (SRS) applying the indicated TCI state. A reference signal (RS) based on the TCI state is a sync signal/physical broadcast channel (SS/PBCH) block associated with same or different physical cell identity (PCI) of a serving cell.

### CROSS-REFERENCE TO RELATED APPLICATIONS

This application claims the priority of Korean Patent Applications No. 10-2024-0071548 filed on May 31, 2024 and No. 10-2025-0032861 filed on Mar. 13, 2025, in the Korean Intellectual Property Office, the disclosure of which is incorporated herein by reference.

### BACKGROUND OF THE DISCLOSURE

### Field of the Disclosure

The present disclosure relates to a mobile communication.

### Related Art

The 5G mobile communication supports a plurality of numerologies or subcarrier spacing (SCS) for supporting various services. For example, when the SCS is 15 kHz, a wide area over conventional cellular bands is supported; in the case of 30 kHz/60 kHz, a dense urban area, lower latency, and wider carrier bandwidth is supported; and when the SCS is larger than 60 kHz or higher, bandwidth larger than 24.25 GHz is supported to overcome phase noise.

The NR frequency band is defined by two types (FR1, FR2) of frequency ranges. The FR1 ranges from 410 MHz to 7125 MHZ, and the FR2 ranges from 24250 MHz to 52600 MHZ, which may correspond to the millimeter wave (mmW) range.

For the convenience of descriptions, in the frequency range used for the NR system, the FR1 may indicate the “sub-6 GHZ range” while the FR2 may indicate the “above 6 GHz range” and may be referred to as the millimeter wave (mmW).

TABLE 1

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As described above, the numerical values of the frequency ranges in the NR system may be changed. For example, the FR1 may include a frequency band ranging from 410 MHz to 7125 MHz as shown in Table 1. In other words, the FR1 may include a frequency band higher than 6 GHz (or 5850, 5900, or 5925 MHz). For example, a frequency band higher than 6 GHz (or 5850, 5900, or 5925 MHz) included in the FR1 may include the unlicensed band. The unlicensed band may be utilized for various applications, which may include communication for vehicles (for example, autonomous driving).

FIG. 1 illustrates a structure of the next-generation mobile communication network.

The 5G Core (5GC) may include various constituting elements, and FIG. 1 shows Access and Mobility Management Function (AMF) 41, Session Management Function (SMF) 42, Policy Control Function (PCF) 43, User Plane Function (UPF) 44, Application Function (AF) 45, Unified Data Management (UDM) 46, and Non-3GPP InterWorking Function (N3IWF) 49, which correspond to part of the constituting elements.

The UE 10 is connected to the data network via the UPF 44 through the Next Generation Radio Access Network (NG-RAN).

The UE 10 may receive a data service even through untrusted non-3rd Generation Partnership Project (3GPP) access, for example, Wireless Local Area Network (WLAN). To connect the non-3GPP access to the core network, the N3IWF 49 may be deployed.

### SUMMARY OF THE DISCLOSURE

The disclosure of this specification aims to provide a method and a user equipment relating to a transmission configuration indicator (TCI) state in 5G NR.

According to one embodiment of this specification, there is provided an operation method of user equipment (UE). The method may comprise: receiving a higher layer configuration including more than one transmission configuration indicator (TCI) state; and if only one TCI state in the more than one TCI state is used as an indicated TCI state, determining a sounding reference signal applying the indicated TCI state. A reference signal (RS) based on the TCI state may be a sync signal/physical broadcast channel (SS/PBCH) block associated with same or different physical cell identity (PCI) of a serving cell.

According to one embodiment of this specification, there is also provided a user equipment (UE). The UE may comprise: at least one processor; and at least one computer memory operably connectable to the at least one processor and storing instructions that, when executed by the at least one processor, perform operations comprising: receiving a higher layer configuration including more than one transmission configuration indicator (TCI) state; and if only one TCI state in the more than one TCI state is used as an indicated TCI state, determining a sounding reference signal applying the indicated TCI state. A reference signal (RS) based on the TCI state may be a sync signal/physical broadcast channel (SS/PBCH) block associated with same or different physical cell identity (PCI) of a serving cell.

According to one embodiment of this specification, there is also provided a semiconductor chipset. The semiconductor chipset may comprise: at least one processor; and at least one memory capable of storing instructions and being connected electrically to the at least one processor operably. An operation, performed when the instructions are executed by the at least one processor, may comprise: receiving a higher layer configuration including more than one transmission configuration indicator (TCI) state; and if only one TCI state in the more than one TCI state is used as an indicated TCI state, determining a sounding reference signal applying the indicated TCI state. A reference signal (RS) based on the TCI state may be a sync signal/physical broadcast channel (SS/PBCH) block associated with same or different physical cell identity (PCI) of a serving cell.

According to one embodiment of this specification, there is also provided a non-volatile computer-readable storage medium recording instructions. The instructions, when executed by one or more processors, instruct the one or more processors to perform operations comprising: receiving a higher layer configuration including more than one transmission configuration indicator (TCI) state; and if only one TCI state in the more than one TCI state is used as an indicated TCI state, determining a sounding reference signal applying the indicated TCI state. A reference signal (RS) based on the TCI state may be a sync signal/physical broadcast channel (SS/PBCH) block associated with same or different physical cell identity (PCI) of a serving cell.

The method or operation(s) may further comprise: assuming that an SRS resource is configured with the TCI state.

The method or operation(s) may further comprise: if the only one TCI state in the more than one TCI state is used the indicated TCI state, determining an uplink (UL) transmission spatial filter from the only one TCI state for dynamic-grant and configured-grant based a physical uplink shared channel (PUSCH) and a physical uplink control channel (PUCCH).

The method or operation(s) may further comprise: if the only one TCI state in the more than one TCI state is used the indicated TCI state, obtaining a quasi co-location (QCL) assumption from the only one TCI state for a demodulation reference signal (DM-RS) of a physical downlink shared channel (PDSCH) and a DM-RS of a physical downlink control channel (PDCCH), and a channel state information reference signal (CSI-RS) applying the indicated TCI state.

The method or operation(s) may further comprise: if more than one TCI state in the more than one TCI state is used the indicated TCI state as a port of a reconfiguration with a sync procedure, assuming that a DM-RS of a PDSCH and a DM-RS of a PDCCH, and a CSI-RS applying the indicated TCI state are quasi co-located with the SS/PBCH block or the CSI-RS resource.

According to one embodiment of this specification, there is provided a method and an user equipment relating to a transmission configuration indicator (TCI) state in 5G NR.

### BRIEF DESCRIPTION OF THE DRAWINGS

FIG. 1 illustrates a structure of the next-generation mobile communication network.

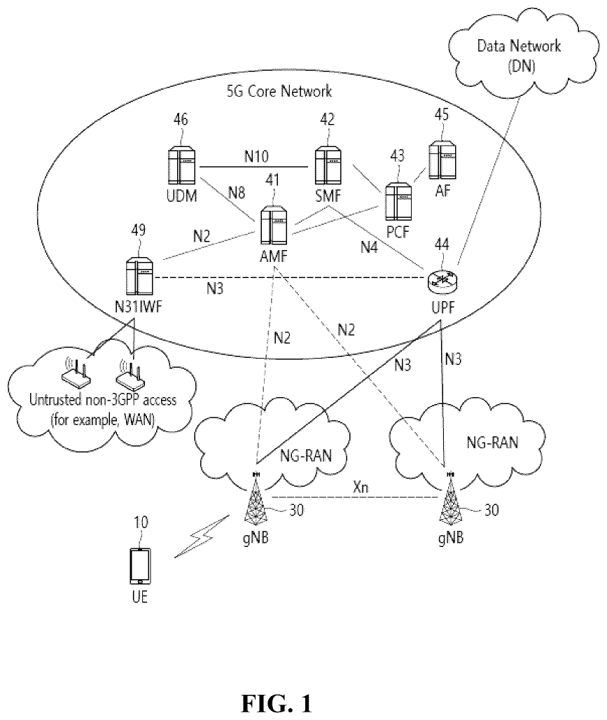

FIG. 2 shows an example of a subframe type in an NR.

FIG. 3 is an example diagram illustrating a procedure according to one embodiment of this specification.

FIG. 4 is a block diagram showing a structure of a UE 100 according to an embodiment.

FIG. 5 illustrates a block diagram of a processor in which the present disclosure is implemented.

### DESCRIPTION OF EXEMPLARY EMBODIMENTS

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the spirit of the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present disclosure will be described in greater detail with reference to the accompanying drawings. In describing the present disclosure, for ease of understanding, the same reference numerals are used to denote the same components throughout the drawings, and repetitive description on the same components will be omitted. Detailed description on well-known arts which are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to its modifications, replacements or equivalents in addition to what is shown in the drawings.

The expression “A or B” as used in the present disclosure may mean “only A”, “only B” or “both A and B”. In other words, “A or B” may be interpreted as “A and/or B” in the present disclosure. For example, in the present disclosure, “A, B or C” may mean “only A”, “only B”, “only C” or “any combination of A, B and C”.

A slash (/) or a comma used in the present disclosure may mean “and/or”. For example, “A/B” may mean “A and/or B”. Accordingly, “A/B” may mean “only A”, “only B”, or “both A and B”. For example, “A, B, C” may mean “A, B or C”.

The phrase “at least one of A and B” as used in the present disclosure may mean “only A”, “only B”, or “both A and B”. Also, the expression “at least one of A or B” or “at least one of A and/or B” may be interpreted to be the same as “at least one of A and B”.

Also, the phrase “at least one of A, B and C” as used in the present disclosure may mean “only A”, “only B”, or “any combination of A, B and C”. Also, the phrase “at least one of A, B or C” or “at least one of A, B and/or C” may mean “at least one of A, B and C”.

Also, parentheses used in the present disclosure may mean “for example”. More specifically, a phrase is written as “control information (PDCCH)”, it may mean that “PDCCH” is proposed as one example of “control information”. In other words, “control information” of the present disclosure is not limited to “PDCCH”, but it may be interpreted that “PDCCH” is proposed as one example of “control information”. Also, when a phrase is written as “control information (namely, PDCCH)”, it may be interpreted that “PDCCH” is proposed as one example of “control information”.

Technical features described individually in one figure of the present disclosure may be implemented separately or simultaneously.

In the drawings, user equipments (UEs) are shown for example. The UE may also be denoted a terminal or mobile equipment (ME). The UE may be a laptop computer, a mobile phone, a PDA, a smartphone, a multimedia device, or other portable device, or may be a stationary device such as a PC or a car mounted device.

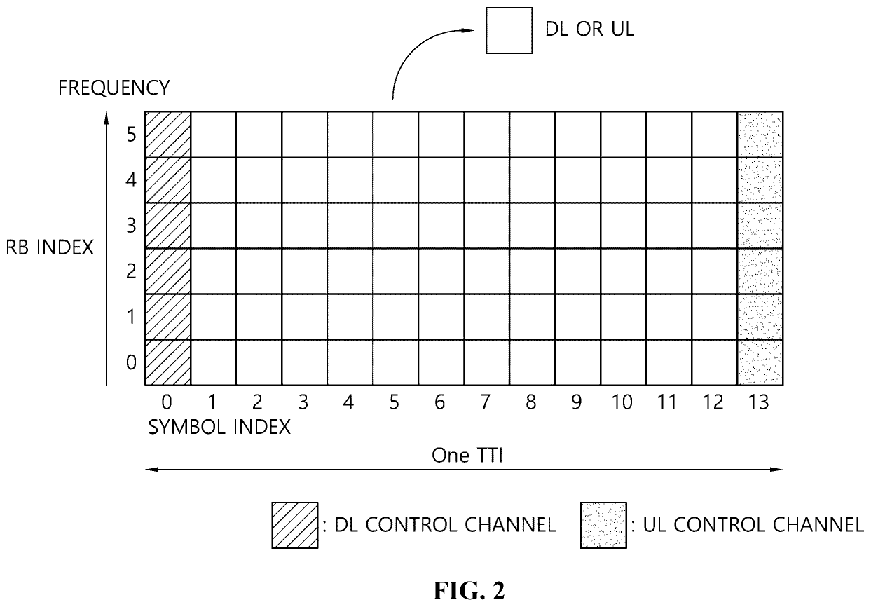

FIG. 2 shows an example of a subframe type in an NR.

A transmission time interval (TTI) shown in FIG. 2 may also be referred to as a new RAT (NR). A subframe (or slot) of FIG. 2 may be used in a TDD system in a new RAT (or NR) in order to minimize data transmission latency. As shown in FIG. 2, just as the current subframe, a subframe (or slot) includes 14 symbols. Symbols located in a front part of the subframe (or slot) may be used for a DL control channel, and symbols located in a rear part of the subframe (or slot) a UL data transmission. According to the above-described subframe (or slot) structure, the downlink transmission and the uplink transmission may be sequentially performed in one subframe (or slot). Therefore, downlink data may be received in the subframe (or slot) and an uplink acknowledgement response (ACK/NACK) may be transmitted from the corresponding subframe (or slot). The above-described subframe (r slot) may also be referred to as a self-contained subframe (or slot). Using the above-described subframe (or slot) structure is advantageous in that it is capable of reducing the time that is consumed for re-transmitting data having reception error, thereby minimizing the final data transmission latency time (or waiting time). In the above-described self-contained subframe (or slot) structure, a time gap may be required during a process of shifting from a Transmission mode to a Reception mode or shifting from a Reception mode to a transmission mode. For this, in the above-described subframe structure, when shifting from a DL to a UL, part of the OFDM symbols may be configured as a Guard Period (GP).

### <Operation Relating to Multi-TRP>

An M-TRP transmission scheme in which M TRPs transmit data to one user equipment (UE) may be divided into two main types, eMBB M-TRP transmission which is a scheme for increasing a transmission rate and URLLC M-TRP transmission which is a scheme for increasing a reception success rate and reducing latency.

In the existing LTE and NR standards, in uplink timing advance configuration/indication, a single timing advance (TA) value is supported for a timing advance group (TAG) to which a specific cell or a group of cells belongs.

Multiple-Transmission and Reception Point (M-TRP) operation may be performed in an environment where there is a large distance difference between a UE and different TRPs. In this case, a propagation delay difference, a slot boundary difference, and an inter-UE panel delay difference may occur between target TRPs of uplink transmission within CC/BWP. In particular, this phenomenon may occur to a greater extent in a non-ideal backhaul operation in which coordination is not performed between TRPs.

As described above, in order to compensate for the timing difference or delay that occurs between the TRPs, uplink timing needs to be determined differently for each TRP. To this end, an operation of connecting/corresponding the TAG to a TCI state of unified TCI (e.g., joint TCI state, separate TCI state (DL TCI state or UL TCI state)) has been agreed.

### Meaning of TCI State/Beam Indication

In the following methods proposed in the present disclosure, using (/mapping) a specific TCI state (or TCI) when receiving data/DCI/UCI for which frequency/time/spatial resources may mean, for DL, estimating a channel from DMRS and receiving/demodulating the data/DCI on the estimated channel using QCL type and QCL RS indicated by a corresponding DL TCI state in the frequency/time/spatial resources. For UL, it may mean transmitting/demodulating DMRS and data/UCI using Tx beam and/or Tx power indicated by a corresponding UL TCI state in the frequency/time/spatial resources.

The UL TCI state contains Tx beam or Tx power information of the UE and may be configured to the UE through another parameter such as spatial relation info instead of the TCI state. The UL TCI state may be indicated directly to UL grant DCI or may mean spatial relation info of SRS resources indicated through an SRI field of the UL grant DCI. Alternatively, the UL TCI state may mean an OL Tx power control parameter (j: index for open loop parameters Po & alpha (maximum 32 parameter value sets per cell), q_d: index of DL RS resource for PL measurement (maximum 4 measurements per cell), 1: closed loop power control process index (maximum 2 processes per cell)) connected to a value indicated through the SRI field of the UL grant DCI. Alternatively, in the R17 NR, the UL TCI state may indicate an UL TCI using the DL grant DCI.

For convenience of explanation, the present disclosure has applied proposal methods assuming cooperative transmission/reception between two TRPs, but it can be extended and applied in 3 or more multi-TRP environments and can be extended and applied in a multi-panel environment. Different TRPs may be recognized by the UE as different TCI states, and the fact that the UE receives/transmits data/DCI/UCI using TCI state 1 means that the UE receives/transmits data/DCI/UCI from/to TRP 1.

In the unified TCI framework introduced in Rel-17 MIMO, the base station may dynamically indicate a specific reference RS to be used as a common beam for DL/UL receive (Rx)/transmit (Tx) beam of the UE using a DL/UL joint TCI state and/or a DL/UL separate TCI state.

The DL/UL joint TCI state may be based on a joint TCI state configured for UL and DL operations. When unifiedTCI-StateType of a serving cell is set to ‘joint’, the joint TCI state may be configured based on dl-OrJointTCI-StateList.

The DL/UL separate TCI state may be based on a DL TCI state and/or an UL TCI state. When unifiedTCI-StateType of the serving cell is set to ‘separate’, the DL TCI state may be configured based on dl-OrJointTCI-StateList, and the UL TCI state may be configured based on ul-TCI-ToAddModList.

The TCI state (e.g., joint/DL TCI state) may be indicated/configured based on dl-OrJoint-TCIStateList within PDSCH-config. The dl-OrJoint-TCIStateList may i) provide a list of up to 128 TCI states (explicitlist-dl-OrJointTCI-StateToAddModList) or ii) indicate a serving cell and a (DL/UL) BWP in which the list of TCI states (dl-OrJointTCI-StateToAddModList) is defined (unifiedTCI-StateRef→ServingCellAndBWP-Id). The TCI state (e.g., joint/DL TCI state) may provide reference RSs for DM-RS of PDSCH, DM-RS of PDCCH, and quasi co-location of CSI-RS. The TCI state (e.g., joint TCI state) may provide reference RSs for determining a dynamic grant based PUSCH, a configured grant based PUSCH, and an uplink (UL) Tx spatial filter for PUCCH resources and SRS.

The UL TCI state may be indicated/configured by ul-TCI-StateList within BWPUplinkDedicated. The ul-TCI-StateList may i) provide a list of up to 64 UL TCI states (explicitlist→ul-TCI-ToAddModList) or ii) indicate a serving cell and an UL BWP in which UL TCI states applicable to the UL BWP are defined (unifiedTCI-StateRef→ServingCellAndBWP-Id).

Rx/Tx beam of DL/UL channel/RS that is not a common beam target may be configured as follows. The TCI state of the unified TCI framework may be configured for each channel/RS based on RRC and MAC CE signaling.

Until Rel-17, standardization was carried out only when M/N, which is the number of DL/UL common beams to be supported in the unified TCI framework (the number of DL/UL TCI states), was M/N=1. In other words, the unified TCI framework was not supported for M-TRP. Specifically, in a serving cell in which two CORESET pool indexes are set (more than one value for the coresetPoolIndex), unifiedTCI-StateType is not set.

Here, M/N denotes the number of DL common beams (M) and/or the number of UL common beams (N). For example, M/N=1 may mean that the number of DL common beams (DL TCI state) and/or the number of UL common beams (UL TCI state) is 1. For example, M/N=1 may mean that the number of DL and UL common beams (joint TCI states) is 1.

If M/N>1 is supported in Rel-18, two or more TCI states and source/target TRP may have a connection relationship.

In particular, in the M-DCI based M-TRP operation, two or more TCI states corresponding to M/N>1 may have a connection relationship with the CORESET pool indexes. As discussed above, the two TA values for multiple TRPs may be configured/indicated by higher layer signaling, such as MAC CE, in the same manner as the existing standard.

In the case of a UE (UE after Rel-17) that supports the unified TCI applied to FR 2, a plurality of TA values may be connected/corresponded to two or more TCI states corresponding to M/N>1. For example, when M/N=2 or/and N=2, a (first/lowest) TCI state firstly configured/indicated may correspond to TA1 (e.g., TAG 1 or TA1 for TAG 1), and a (second/second-lowest) TCI state secondly configured/indicated may correspond to TA2 (e.g., TAG 2 or TA2 for TAG 2)

Specifically, a specific payload may be included/added/defined in the MAC CE to configure/assign/activate the TA value to each of the two or more TCI states corresponding to M/N>1. For example, a payload for a target TCI state(s) (group) for assigning each TA value (e.g., TA1 and TA2) may exist in an MAC CE message configuring the two TA values.

In the TCI state configuration (TCI state pool) for unified TCI, the two TRP-specific TA values (e.g., two TAGs or TAs corresponding to two TAGs) may be connected/corresponding to a specific TCI state(s) (group). When two TA values are connected/corresponded to the two TCI states corresponding to M/N>1, the UE may perform UL transmission using a TRP-specific TA value connected to each TCI state in the UL transmission using each TCI state. For example, timing of UL transmission based on a first TCI state may be determined based on TA related to the first TCI state (e.g., a first TAG or a first TA for a first TAG), and timing of UL transmission based on a second TCI state may be determined based on TA related to the second TCI state (e.g., a second TAG or a second TA for a second TAG).

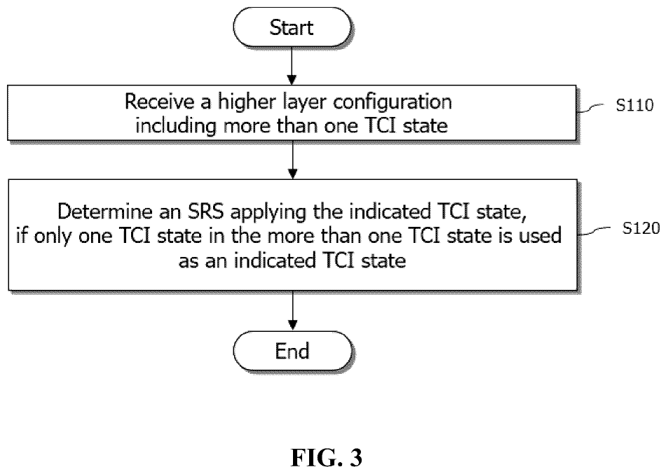

FIG. 3 is an example diagram illustrating a procedure according to one embodiment of this specification.

Referring to FIG. 3, a user equipment (UE) may receive a higher layer configuration including more than one transmission configuration indicator (TCI) state (S110).

If only one TCI state in the more than one TCI state is used as an indicated TCI state, the UE may determine a sounding reference signal (SRS) applying the indicated TCI state.

A reference signal (RS) based on the TCI state may be a sync signal/physical broadcast channel (SS/PBCH) block associated with same or different physical cell identity (PCI) of a serving cell.

The UE may assume that an SRS resource is configured with the TCI state.

If the only one TCI state in the more than one TCI state is used the indicated TCI state, the UE may determine an uplink (UL) transmission spatial filter from the only one TCI state for dynamic-grant and configured-grant based a physical uplink shared channel (PUSCH) and a physical uplink control channel (PUCCH).

If the only one TCI state in the more than one TCI state is used the indicated TCI state, the UE may obtain a quasi co-location (QCL) assumption from the only one TCI state for a demodulation reference signal (DM-RS) of a physical downlink shared channel (PDSCH) and a DM-RS of a physical downlink control channel (PDCCH), and a channel state information reference signal (CSI-RS) applying the indicated TCI state.

If more than one TCI state in the more than one TCI state is used the indicated TCI state as a port of a reconfiguration with a sync procedure, the UE may assume that a DM-RS of a PDSCH and a DM-RS of a PDCCH, and a CSI-RS applying the indicated TCI state are quasi co-located with the SS/PBCH block or the CSI-RS resource.

### SUMMARY OF THE EMBODIMENTS OF THIS SPECIFICATION

### <Antenna Ports Quasi Co-Location>

After a UE receives an initial higher layer configuration of dl-OrJointTCI-StateList where more than one TCI-State can be used as an indicated TCI state and before application of an indicated TCI state from the configured TCI states:
The UE assumes that DM-RS of PDSCH and DM-RS of PDCCH and the CSI-RS applying the indicated TCI state are quasi co-located with the SS/PBCH block the UE identified during the initial access procedure

After a UE receives an initial higher layer configuration of dl-OrJointTCI-StateList where more than one TCI-State can be used as an indicated TCI state or an initial higher layer configuration of ul-TCI-StateList where more than one TCI-UL-State can be used as an indicated TCI state and before application of an indicated TCI state from the configured TCI states:
The UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant or a MsgA PUSCH transmission during the initial access procedure

After a UE receives a higher layer configuration of dl-OrJointTCI-StateList where more than one TCI-State can be used as an indicated TCI state as part of a Reconfiguration with sync procedure and before applying an indicated TCI state from the configured TCI states:
The UE assumes that DM-RS of PDSCH and DM-RS of PDCCH, and the CSI-RS applying the indicated TCI state are quasi co-located with the SS/PBCH block or the CSI-RS resource the UE identified during the random access procedure initiated by the Reconfiguration with sync procedure.

After a UE receives a higher layer configuration of dl-OrJointTCI-StateList where more than one TCI-State can be used as an indicated TCI state or a higher layer configuration of ul-TCI-StateList where more than one TCI-UL-State can be used as an indicated TCI state as part of a Reconfiguration with sync procedure and before applying an indicated TCI state from the configured TCI states:
The UE assumes that the UL TX spatial filter, if applicable, for dynamic-grant and configured-grant based PUSCH and PUCCH, and for SRS applying the indicated TCI state, is the same as that for a PUSCH transmission scheduled by a RAR UL grant or a MsgA PUSCH transmission during random access procedure initiated by the Reconfiguration with sync procedure.

If a UE receives a higher layer configuration of dl-OrJointTCI-StateList where only one TCI-State can be used as an indicated TCI state, the UE obtains the QCL assumptions from that TCI state for DM-RS of PDSCH and DM-RS of PDCCH, and the CSI-RS applying the indicated TCI state.

If a UE receives a higher layer configuration of dl-OrJointTCI-StateList where only one TCI-State can be used as an indicated TCI state or a higher layer configuration of ul-TCI-StateList where only one TCI-UL-State can be used as an indicated TCI state, the UE determines an UL TX spatial filter, if applicable, from that TCI state for dynamic-grant and configured-grant based PUSCH and PUCCH, and SRS applying the indicated TCI state.

### <UE Sounding Procedure>

When the UE is configured dl-OrJointTCI-StateList or ul-TCI-StateList, the UE can assume that SRS resource(s) in any SRS resource set, except SRS resource set for positioning and an SRS resource set configured with followUnifiedTCI-StateSRS, can be configured with TCI-State or TCI-UL-State or updated. The reference RS in the TCI-State can be a CSI-RS resource in a NZP-CSI-RS-ResourceSet configured with higher layer parameter repetition, a CSI-RS resource in an NZP-CSI-RS-ResourceSet configured with higher layer parameter trs-Info, or SS/PBCH block associated with the same or different PCI from the PCI of the serving cell. The reference RS in the TCI-UL-State(s) can be a CSI-RS resource in a NZP-CSI-RS-ResourceSet configured with higher layer parameter repetition, a CSI-RS resource in an NZP-CSI-RS-ResourceSet configured with higher layer parameter trs-Info, an SRS resource with the higher layer parameter usage set to ‘beamManagement’, or SS/PBCH block associated with the same or different PCI from the PCI of the serving cell.

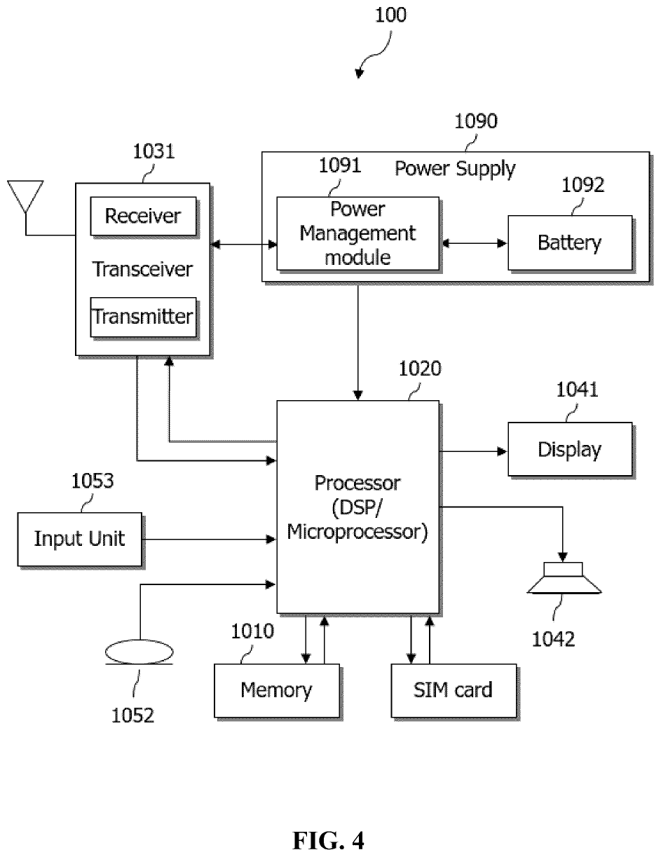

FIG. 4 is a block diagram showing a structure of a UE 100 according to an embodiment.

A UE 100 includes a memory 1010, a processor 1020, a transceiver 1031, a power management module 1091, a battery 1092, a display 1041, an input unit 1053, a speaker 1042, a microphone 1052, a subscriber identification module (SIM) card, and one or more antennas.

The processor 1020 may be configured to implement the proposed functions, procedures, and/or methods described in the present specification. Layers of a radio interface protocol may be implemented in the processor 1020. The processor 1020 may include application-specific integrated circuits (ASICs), other chipsets, logic circuits, and/or data processing units. The processor 1020 may be an application processor (AP). The processor 1020 may include at least one of a digital signal processor (DSP), a central processing unit (CPU), a graphics processing unit (GPS), and a modulator and demodulator (modem). An example of the processor 1020 may include an SNAPDRAGON™ series processor manufactured by Qualcomm®, an EXYNOS™ series processor manufactured by Samsung®, an A series processor manufactured by Apple®, a HELIO™ series processor manufactured by MediaTek®, an ATOM™ series processor manufactured by INTEL®, or a corresponding next-generation processor.

The power management module 1091 manages power for the processor 1020 and/or the transceiver 1031. The battery 1092 supplies power to the power management module 1091. The display 1041 outputs a result processed by the processor 1020. The input unit 1053 receives an input to be used by the processor 1020. The input unit 1053 may be displayed on the display 1041. The SIM card is an integrated circuit used to safely store an international mobile subscriber identity (IMSI) used to identify and authenticate a subscriber and a key related thereto in a portable phone and a portable phone device such as a computer. Contacts information may be stored in many SIM cards.

The memory 1010 is operatively coupled to the processor 1020, and stores a variety of information for operating the processor 1020. The memory 1010 may include a read-only memory (ROM), a random access memory (RAM), a flash memory, a memory card, a storage medium, and/or other equivalent storage devices. When the embodiment is implemented in software, the techniques explained in the present specification can be implemented with a module (i.e., procedure, function, etc.) for performing the functions explained in the present specification. The module may be stored in the memory 1010 and may be performed by the processor 1020. The memory 1010 may be implemented inside the processor 1020. Alternatively, the memory 1010 may be implemented outside the processor 1020, and may be coupled to the processor 1020 in a communicable manner by using various well-known means.

The transceiver 1031 is operatively coupled to the processor 1020, and transmits and/or receives a radio signal. The transceiver 1031 includes a transmitter and a receiver. The transceiver 1031 may include a baseband signal for processing a radio frequency signal. The transceiver controls one or more antennas to transmit and/or receive a radio signal. In order to initiate communication, the processor 1020 transfers command information to the transceiver 1031, for example, to transmit a radio signal constituting voice communication data. The antenna serves to transmit and receive a radio signal. When the radio signal is received, the transceiver 1031 may transfer a signal to be processed by the processor 1020, and may convert the signal into a baseband signal. The processed signal may be converted into audible or readable information which is output through the speaker 1042.

The speaker 1042 outputs a result related to a sound processed by the processor 1020. The microphone 1052 receives a sound-related input to be used by the processor 1020.

A user presses (or touches) a button of the input unit 1053 or drives voice (activates voice) by using the microphone 1052 to input command information such as a phone number or the like. The processor 1020 receives the command information, and performs a proper function such as calling the phone number or the like. Operational data may be extracted from the SIM card or the memory 1010. In addition, the processor 1020 may display command information or operational information on the display 1041 for user's recognition and convenience.

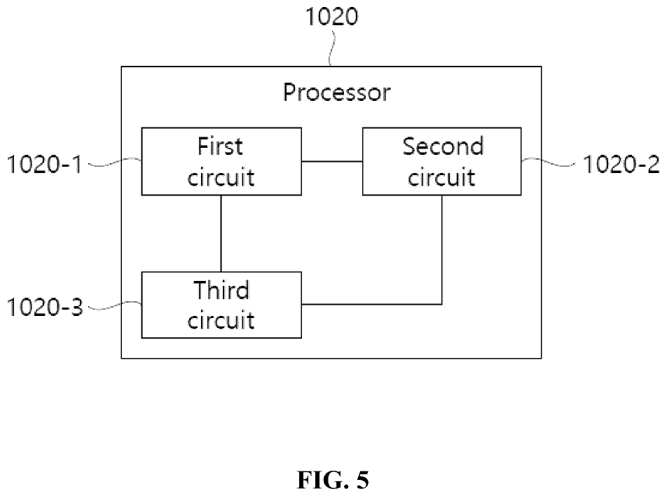

FIG. 5 illustrates a block diagram of a processor in which the present disclosure is implemented.

As may be seen from FIG. 5, the processor 1020 in which the present disclosure is implemented may include a plurality of circuitry to implement functions, procedures and/or methods described in the present disclosure. For example, the processor 1020 may include a first circuit 1020-1, a second circuit 1020-2, and a third circuit 1020-3. Also, although not shown in the figure, the processor 1020 may include more circuits. Each circuit may include a plurality of transistors.

The first circuit 1020-1 may receive a higher layer configuration including more than one TCI state.

If only one TCI state in the more than one TCI state is used as an indicated transmission configuration indicator (TCI) state, The second circuit 1020-2 may determine a sounding reference signal applying the indicated TCI state.

A reference signal (RS) based on the TCI state may be a sync signal/physical broadcast channel (SS/PBCH) block associated with same or different physical cell identity (PCI) of a serving cell.

The third circuit 1020-3 may assume that an SRS resource is configured with the TCI state.

If the only one TCI state in the more than one TCI state is used the indicated TCI state, the fourth circuit may determine an uplink (UL) transmission spatial filter from the only one TCI state for dynamic-grant and configured-grant based a physical uplink shared channel (PUSCH) and a physical uplink control channel (PUCCH).

If the only one TCI state in the more than one TCI state is used the indicated TCI state, the fifth circuit may obtain a quasi co-location (QCL) assumption from the only one TCI state for a demodulation reference signal (DM-RS) of a physical downlink shared channel (PDSCH) and a DM-RS of a physical downlink control channel (PDCCH), and a channel state information reference signal (CSI-RS) applying the indicated TCI state.

If more than one TCI state in the more than one TCI state is used the indicated TCI state as a port of a reconfiguration with a sync procedure, the sixth circuit may assume that a DM-RS of a PDSCH and a DM-RS of a PDCCH, and a CSI-RS applying the indicated TCI state are quasi co-located with the SS/PBCH block or the CSI-RS resource.

The processor 1020 may be called Application-Specific Integrated Circuit (ASIC) or Application Processor (AP) and may include at least one of a Digital Signal Processor (DSP), a Central Processing Unit (CPU), and a Graphics Processing Unit (GPU).

The processor may be equipped in the UE.

In the above, preferred embodiments have been described by way of example, but the disclosure of the present specification is not limited to these specific embodiments, and may be modified, changed, or modified in various forms within the scope described in the spirit and claims of the present specification. It can be improved.

In the example system described above, the methods are described on the basis of a flow chart as a series of steps or blocks, but the order of steps described is not limited, and some steps may occur simultaneously or in a different order than other steps as described above. there is. Additionally, those skilled in the art will understand that the steps shown in the flowchart are not exclusive and that other steps may be included or one or more steps in the flowchart may be deleted without affecting the scope of rights.

The claims set forth herein may be combined in various ways. For example, the technical features of the method claims of this specification may be combined to implement a device, and the technical features of the device claims of this specification may be combined to implement a method. Additionally, the technical features of the method claims of this specification and the technical features of the device claims may be combined to implement a device, and the technical features of the method claims of this specification and technical features of the device claims may be combined to implement a method.

1. An operation method of user equipment (UE), comprising:
receiving a higher layer configuration including more than one transmission configuration indicator (TCI) state; and
if only one TCI state in the more than one TCI state is used as an indicated TCI state, determining a sounding reference signal (SRS) applying the indicated TCI state,
wherein a reference signal (RS) based on a first TCI state is a sync signal/physical broadcast channel (SS/PBCH) block associated with a second physical cell identity (PCI) different from a first PCI of a serving cell.

2. The method of claim 1, further comprising:
assuming that an SRS resource is configured with the first TCI state.

3. The method of claim 1, further comprising:
if the only one TCI state in the more than one TCI state is used as the indicated TCI state, determining an uplink (UL) transmission spatial filter from the only one TCI state for dynamic-grant and configured-grant based a physical uplink shared channel (PUSCH) and a physical uplink control channel (PUCCH).

4. The method of claim 1, further comprising:
if the only one TCI state in the more than one TCI state is used as the indicated TCI state, obtaining a quasi co-location (QCL) assumption from the only one TCI state for a demodulation reference signal (DM-RS) of a physical downlink shared channel (PDSCH) and a DM-RS of a physical downlink control channel (PDCCH), and a channel state information reference signal (CSI-RS) applying the indicated TCI state.

5. The method of claim 1, wherein
if more than one TCI state in the more than one TCI state is used as the indicated TCI state as a port of a reconfiguration with a sync procedure, assuming that a DM-RS of a PDSCH and a DM-RS of a PDCCH, and a CSI-RS applying the indicated TCI state are quasi co-located with the SS/PBCH block or the CSI-RS resource.

6. A user equipment (UE), the UE comprising:
at least one processor; and
at least one computer memory operably connectable to the at least one processor and storing instructions that, when executed by the at least one processor, perform operations comprising:
receiving a higher layer configuration including more than one transmission configuration indicator (TCI) state; and
if only one TCI state in the more than one TCI state is used as an indicated TCI state, determining a sounding reference signal (SRS) applying the indicated TCI state,
wherein a reference signal (RS) based on a first TCI state is a sync signal/physical broadcast channel (SS/PBCH) block associated with a second physical cell identity (PCI) different from a first PCI of a serving cell.

7. The UE of claim 6, wherein the operations further comprise:
assuming that a SRS resource is configured with the first TCI state.

8. The UE of claim 6, wherein the operations further comprise:
if the only one TCI state in the more than one TCI state is used as the indicated TCI state, determining an uplink (UL) transmission spatial filter from the only one TCI state for dynamic-grant and configured-grant based a physical uplink shared channel (PUSCH) and a physical uplink control channel (PUCCH).

9. The UE of claim 6, wherein the operations further comprise:
if the only one TCI state in the more than one TCI state is used as the indicated TCI state, obtaining a quasi co-location (QCL) assumption from the only one TCI state for a demodulation reference signal (DM-RS) of a physical downlink shared channel (PDSCH) and a DM-RS of a physical downlink control channel (PDCCH), and a channel state information reference signal (CSI-RS) applying the indicated TCI state.

10. The UE of claim 6, wherein the operations further comprise:
if more than one TCI state in the more than one TCI state is used as the indicated TCI state as a port of a reconfiguration with a sync procedure, assuming that a DM-RS of a PDSCH and a DM-RS of a PDCCH, and a CSI-RS applying the indicated TCI state are quasi co-located with the SS/PBCH block or the CSI-RS resource.

11. A semiconductor chipset, comprising:
at least one processor; and
at least one memory capable of storing instructions and being connected electrically to the at least one processor operably,
wherein an operation, performed when the instructions are executed by the at least one processor, includes:
receiving a higher layer configuration including more than one transmission configuration indicator (TCI) state; and
if only one TCI state in the more than one TCI state is used as an indicated TCI state, determining a sounding reference signal (SRS) applying the indicated TCI state,
wherein a reference signal (RS) based on a first TCI state is a sync signal/physical broadcast channel (SS/PBCH) block associated with a second physical cell identity (PCI) different from a first PCI of a serving cell.

12. The semiconductor chipset of claim 11, wherein the operations further comprise:
assuming that a SRS resource is configured with the first TCI state.

13. The semiconductor chipset of claim 11, wherein the operations further comprise:
if the only one TCI state in the more than one TCI state is used as the indicated TCI state, determining an uplink (UL) transmission spatial filter from the only one TCI state for dynamic-grant and configured-grant based a physical uplink shared channel (PUSCH) and a physical uplink control channel (PUCCH).

14. The semiconductor chipset of claim 11, wherein the operations further comprise:
if the only one TCI state in the more than one TCI state is used as the indicated TCI state, obtaining a quasi co-location (QCL) assumption from the only one TCI state for a demodulation reference signal (DM-RS) of a physical downlink shared channel (PDSCH) and a DM-RS of a physical downlink control channel (PDCCH), and a channel state information reference signal (CSI-RS) applying the indicated TCI state.

15. The semiconductor chipset of claim 11, wherein the operations further comprise:
if more than one TCI state in the more than one TCI state is used as the indicated TCI state as a port of a reconfiguration with a sync procedure, assuming that a DM-RS of a PDSCH and a DM-RS of a PDCCH, and a CSI-RS applying the indicated TCI state are quasi co-located with the SS/PBCH block or the CSI-RS resource.
